(19) United States
(12) Patent Application Publication
(10) Pub. No.: US 2009/0116912 A1
(43) Pub. Date: May 7, 2009

(54) Tool Support for Tools on Machine Tools

(75) Inventors: Karlheinz Jansen, Schutterwald (DE); Klaus Maier, Offenburg (DE)

Correspondence Address: GUDRUN E. HUCKETT DRAUDT, SCHUBERTSTR. 15A, WUPPERTAL, 42289, DE

(73) Assignee: WTO WERKZEUG-EINRICHTUNGEN GMBH, Ohlsbach (DE)

(21) Appl. No.: 11/574,585

(22) PCT Filed: Aug. 16, 2005
(86) PCT No.: PCT/DE05/01445

§ 371 Date: Oct. 1, 2007

(30) Foreign Application Priority Data
Sep. 2, 2004 (DE) 10 2004 042 520.5

(51) Int. Cl. B26D 1/00

(52) U.S. Cl. 407/104

(57) ABSTRACT

A tool support for tools on machine tools has a tool support receptacle and a tool clamping insert arranged in the tool support receptacle and receiving a tool. At least one clamping screw secures the tool clamping insert in the tool support receptacle. The tool support receptacle has at least one continuous threaded bore having an axis that is positioned angularly relative to an axis of rotation of the tool. The at least one clamping screw when screwed into the at least one threaded bore engages in a tightened state a radial circumferential outer surface of the tool clamping insert.

The invention relates to a tool support for tools on machine tools according to the preamble of claim 1.

Tool supports serve for receiving stationary or rotating tools for machining workpieces. These tools can be drills, milling tools, sawblades or other cutting tools that are generally provided and suitable for machining workpieces.

A tool support for tools on machine tools of the aforementioned kind is disclosed in DE 102 19 600 B4. This tool support has a tool support receptacle with a conical inner bore. This conical inner bore serves for receiving a tool support receptacle in the form of a collet. Clamping screws are provided for fixation of the tool clamping insert in the tool support receptacle. For this purpose, the tool clamping insert has axis-parallel bores through which clamping screws can be pushed and screwed into the tool support receptacle at the end face. In this connection, the tool support receptacle and the tool clamping insert rest against one another by means of matching plane surfaces at the end face.

When changing the tool clamping insert, the clamping screws must be completely unscrewed. On the one hand, this increases the tool changing time significantly; on the other hand, the clamping screws can be lost. Moreover, the accessibility of the clamping screws is no longer provided when the cutting tool diameter (for example, a sawblade) surpasses the reference circle of the clamping screws.

Based on this, it is an object of the present invention to simplify and make more flexible the fixation of the tool clamping insert in the tool support receptade in the case of a tool support for tools on machine tools of the aforementioned kind.

The technical solution is characterized by the features of the characterizing portion of claim 1.

The basic idea of the tool support according to the present invention for tools on machine tools resides in that the fixation of the tool clamping insert in the tool support receptacle is realized laterally, wherein the clamping screws secure the tool clamping insert on its outside surface through appropriate threaded bores. In this connection, at least one clamping screw, preferably several clamping screws, typically 2 or 3 clamping screws are provided that are distributed uniformly about the circumference. The great advantage of this fixation device resides in that the clamping screws, when changing the tool clamping insert, must only be released and not completely unscrewed. This reduces, on the one hand, the changing time of the tool clamping insert significantly; on the other hand, the clamping screws will not be lost. Moreover, the clamping screws remain within the tool support receptacle when operating without a tool clamping insert. The clamping screws then protect the threaded bores from becoming soiled. A further great advantage resides in that independent of the diameter of the cutting tool the clamping screws are always accessible so that accessibility is always guaranteed.

A first variant in the arrangement of the clamping screws provides according to the embodiment of claim 2 that the axis of the threaded bore is perpendicular to the tool axis. In this way, a radial arrangement of the damping screws is realized.

As an alternative according to claim 3, the clamping screws can also be arranged at a slant, preferably at a slant from the front. Because of the slight incline of the clamping screws, even more space is saved so that by this shortening in the axial direction the total length is shortened farther. By means of the relatively minimal slant, a substantially unhindered access to the clamping screws is still possible. When suitably selecting the slant angle (e.g. 30 degrees to the radial line), standard screws instead of special screws can be used as clamping screws.

A preferred technical realization of the clamping screws according to claim 4 proposes that the clamping screws have a clamping cone at the front end and the circumferential outer surface of the tool clamping insert has a matching inner cone.

In this way, a safe fixation, on the one hand, and a reproducible clamping action between the tool support receptacle and the tool clamping insert, on the other hand, are realized.

The principal idea of the embodiment according to claim 5 resides in that, when securing the tool clamping insert in the tool support receptacle, clamping of the two aforementioned parts is realized at the same time in that the tool clamping insert is moved axially into the interior of the tool support receptacle.

A preferred embodiment is proposed in claim 6. Accordingly, a fixation of the tool clamping insert in the tool support receptacle is designed very flexibly. This is so because the fixation system is independent of the orientation the threaded bore of the clamping screw within this tool support receptacle. The front end of the clamping screw can always be secured within one and the same cutout that is formed in the tool clamping insert. This means in practice that for a tool support receptacle with a different orientation for the clamping screw it is not necessary to provide a matching tool clamping insert. Instead, one and the same tool clamping insert can be used for tool support receptacles with different orientations of the threaded bores.

Preferably, according to the embodiment of claim 7, a tool clamping insert can be essentially of a conical configuration.

A preferred embodiment proposes according to claim 8 that the clamping screw does not engage on the conical body proper but on a forward cylindrical projection in the area, i.e. shortly behind the plane contact surface between the tool clamping insert and the tool support receptacle.

In this connection, the tool clamping insert according to the embodiment of claim 9 has preferably a cylindrical projection at its rear. This cylindrical projection is supported additionally on the matching bore in the tool support receptacle. Fit and positional tolerances of the parts are expediently selected such that a support action is provided. This is primarily advantageous when during milling great transverse forces result or in the case of great cantilever lengths. By means of this additional supporting action a substantially improved milling precision and milling stability are achieved.

The embodiment according to claim 10 proposes a seal. This is advantageous when via a passage through the tool support receptacle from the rear cooling medium is supplied at high pressures, typically 10 bar to several 100 bar, for cooling cutting tools with inner cooling action. When not employing the seal, it cannot be prevented, because of the high pressure, that the pressure that is being applied generates a very great axial force that is significantly greater than the clamping force or the force at break of the clamping screws.

According to the embodiment of claim 11, in the case of tool clamping inserts with cylindrical bore or with an inner cone for collets, an adjusting screw can preferably be directly inserted into the tool clamping insert. By means of this adjusting screw the length of the cutting tools can be pre-adjusted already before mounting the tool clamping insert in the tool support receptacle. This shortens the changing process and thus the downtime of a machine tool significantly. Should the axial forces during machining be greater than the clamping forces, the adjusting screw additionally serves as a length stop so that the cutting tool cannot be forced farther into the tool clamping insert.

Finally, an embodiment according to claim 12 proposes a circumferential centering action. The positioning pin has the task of achieving an unequivocal positional orientation between the tool clamping insert and the tool support receptacle. This is advantageous in order to avoid an unnecessary searching step when screwing in the clamping screw. Only when the position of the positioning pin coincides with the position of the threaded bore, mounting is possible. In the case of position-oriented tools (e.g. bore rods) used in mass production, such unequivocal positioning is of great advantage for securing the process.

Embodiments of a tool support according to the invention for tools on machine tools will be explained in the following with the aid of the drawings. It is shown in:

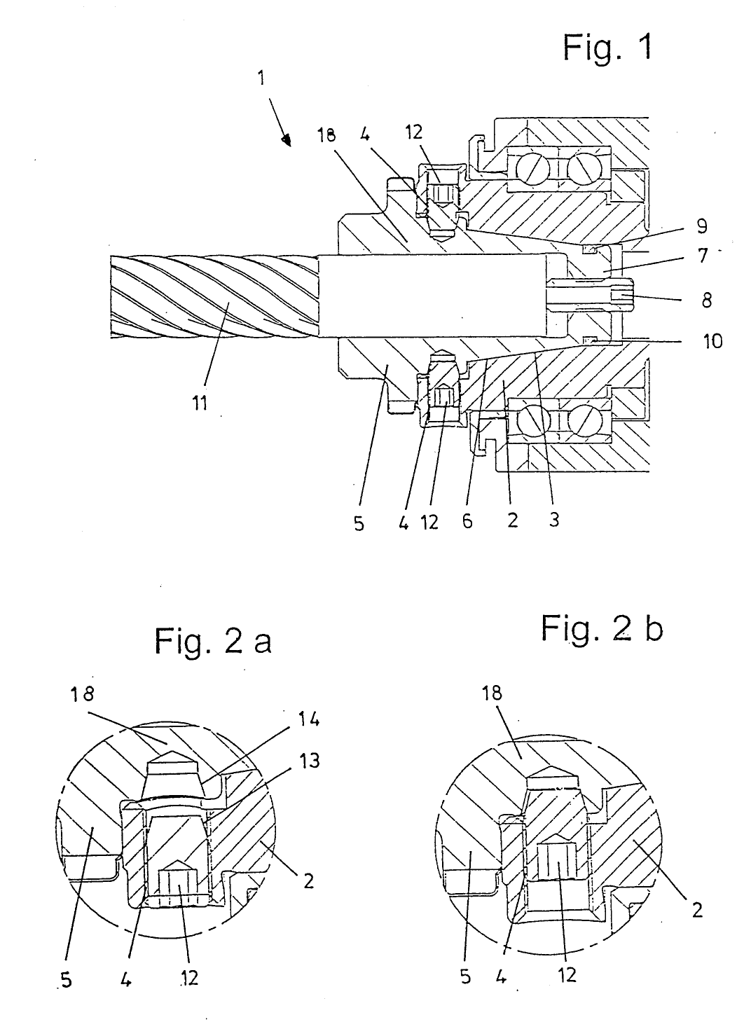

FIG. 1 a longitudinal section illustration of the tool support of a first embodiment;

FIG. 2a a detail view of FIG. 1 in the area of the clamping screw in the untightened state;

FIG. 2b an illustration in accordance with FIG. 2a showing the clamping screw in the tightened state;

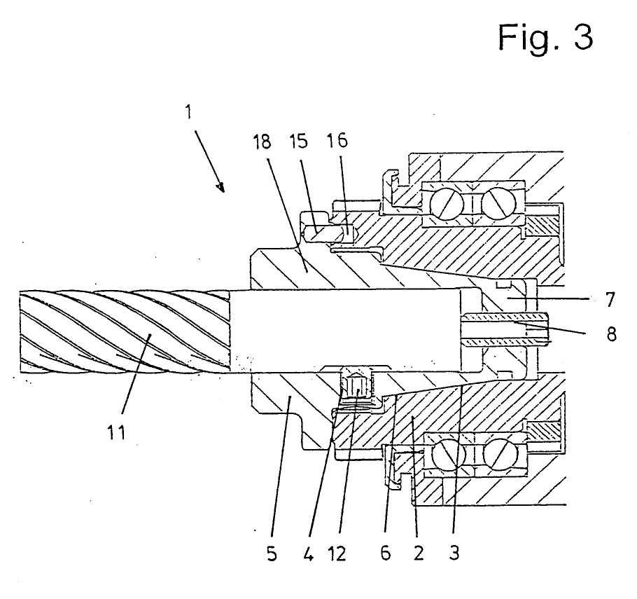

FIG. 3 the tool support of FIG. 1 but in a section taken at a different section plane;

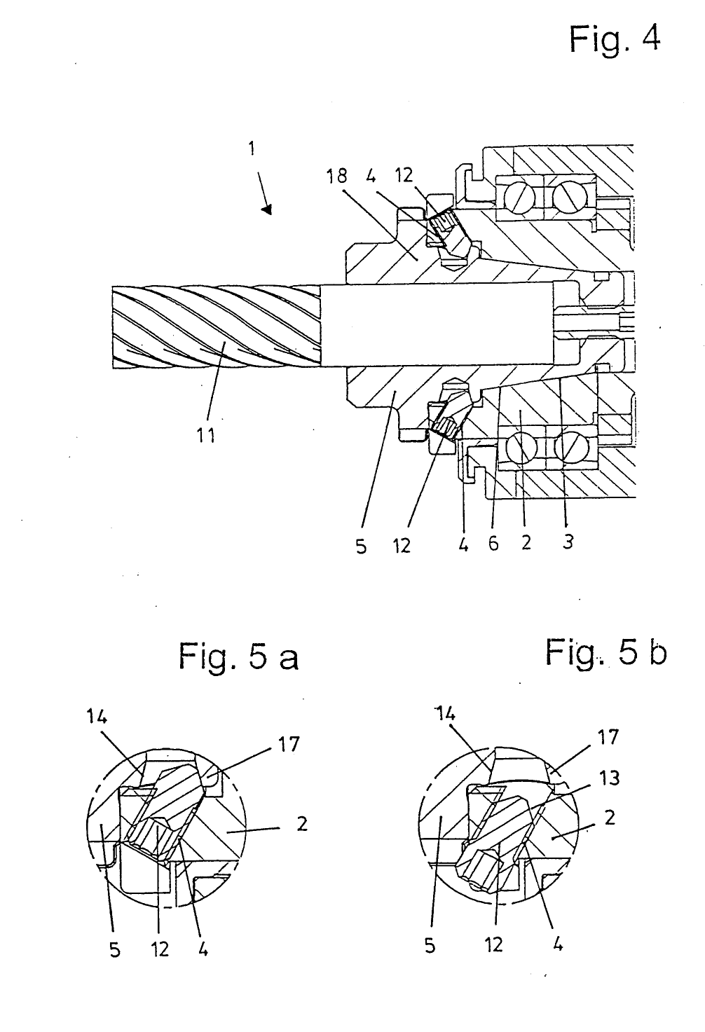

FIG. 4a longitudinal section of the tool support of a second embodiment;

FIG. 5a a detail view of FIG. 4 in the area of the clamping screw wherein the clamping screw is shown in the tightened state;

FIG. 5b an illustration in accordance with FIG. 5a showing the clamping screw in the untightened state.

FIGS. 1 to 3 show a first embodiment and FIGS. 4 and 5 show a second embodiment of a tool support for tools on machine tools.

The first embodiment of FIGS. 1 to 3 shows a tool support 1 with a rotatable tool support receptacle 2. This tool support receptacle 2 has an inner cone 3. In the front area of the tool support receptacle 2 radial threaded bores 4 are provided.

The tool support 1 has moreover a tool clamping insert 5. It is secured by means of an outer cone 6 in the inner cone 3 of the tool support receptacle 2. On the rearward end the tool clamping insert 5 has a cylindrical projection 7. A longitudinally adjustable adjusting screw 8 is provided at the bottom of the projection. About its circumference, the cylindrical projection 7 of the tool clamping insert 5 has a circumferential groove 9 in which an O-ring 10 is arranged. At the forward end, the tool clamping insert 5 has a cylindrical projection 18.

The tool 11 correlated with the tool support 1 is secured in the central bore of the tool clamping insert 5. In the illustrated embodiment, this tool 11 is a drill bit. Instead, other tools 11, for example, milling tools or sawblades, are conceivable. The tool clamping insert 5 can be e.g. a collet receptade.

The function is as follows:

The tool clamping insert 5 with its tool 11 is to be secured in the inner cone 3 of the tool support receptacle 2 after, for example, an exchange of the tool clamping insert 5 has taken place. Clamping screws 12 are provided for fixation and are screwed into the threaded bores 4.

The untightened state of these clamping screws 12 is illustrated in FIG. 2a. It can be seen that the clamping screws 12 have at their front end a clamping cone 13. This clamping cone 13 matches a recess in the form of an inner cone 14 provided in the outer surface of the tool clamping insert 5.

In this not yet completely unscrewed position of the clamping screws 12, the tool clamping insert 5 with its tool 11 can be removed from the inner cone 3 of the tool support receptacle 2 and a different tool clamping insert 5 can be inserted. After insertion of the tool clamping insert 5 into the inner cone 4 of the tool support receptacle 2, wherein the adjusting screw 8 serves as a stop for the tool 11 and wherein the tool support receptacle 2 and the tool clamping insert 5 rest with their end faces in plane contact against one another, the fixation and centering are realized such that the clamping screws 12 are screwed in until the respective clamping cone 13 of the clamping screw 12 comes to rest in the inner cone 14 of the tool clamping insert 5 in the area of the cylindrical projection 18. This situation is illustrated in FIG. 2b. In this connection, the tool clamping insert 5 is moved to the right in the drawing by cooperation of the clamping cone 13 with the matching inner cone 14; this is indicated in the drawing by the gap being formed between the clamping cone 13 and the inner cone 14 on the left side of the damping screw 12.

In the fixed state, the cylindrical projection 7 of the tool clamping insert 5 rests in a matching cylindrical recess of the tool support receptacle 5. This cylindrical projection 7 serves as a support in the case of great transverse forces. In this way, a very high milling precision and milling stability are achieved.

The O-ring 10 serves as a seal between the tool clamping insert 5 and the tool support receptacle 2 when, for example, cooling medium is supplied at high pressures for cooling the tool 11 with inner cooling action.

For a further change of the tool clamping insert 5, the clamping screws 12 are unscrewed somewhat (as illustrated in FIG. 2a) so that the tool clamping insert 5 is released again.

The illustration of FIG. 3 taken at a somewhat different section plane shows a positioning pin 15 that is axis-parallel arranged in the area of the plane surfaces in the tool support receptacle 2 so as be oriented toward the rear. An end face cutout 16 in the tool support receptacle 2 corresponds to this positioning pin 15. This positioning pin 15 has the task of providing an unequivocal positional orientation between the tool clamping insert 15 and the tool support receptacle 2. This is advantageous in order to avoid an unnecessary searching step when screwing the clamping screws 12 into the threaded bores 4. Mounting is possible only when the position of the positioning pin 15 coincides with the cutout 16.

The embodiment of FIGS. 4 and 5 differs from the first embodiment in regard to the orientation of the threaded bores 4 or in the orientation of the clamping screws 12. While in the first embodiment the alignment of the clamping screws 12 is exactly radial, i.e., perpendicular to the axis of the tool 11, in the second embodiment the clamping screws 12 are positioned so as to be slanted at an angle. Accordingly, the clamping screws 12 are accessible from the front at a slant. The angle is approximately 30 degrees in the illustrated embodiment.

The clamping screw 12 still has a clamping cone 13 at the front end. The tool clamping insert 5 has a matching stop surface 17 which is formed in the recess in the form of an inner cone 14 of the tool clamping insert 5. As shown in the drawings of both embodiments, the recess with the inner cone 14 in the tool clamping insert 5 is configured such that the clamping screw 12 can be screwed in radially as well as at a slant, in particular at a slant from the front. This depends on the threaded bore 4 in the tool support receptacle 2.

The function of this second embodiment is in principle the same as that of the first embodiment, i.e., when changing the tool clamping insert 5 the clamping screws 12 are unscrewed somewhat so that the tool clamping insert 5 is released and can be removed. After insertion of a new tool clamping insert 5, the clamping screws 12 are tightened again so that the they engage the area of the cylindrical projection 18 of the tool clamping insert 5.

### LIST OF REFERENCE NUMERALS

1 tool support
2 tool support receptacle
3 innercone
4 threaded bore
5 tool clamping insert
6 outer cone
7 cylinder projection
8 adjusting screw
9 circumferential groove
10 O-ring
11 tool
12 clamping screw
13 clamping cone
14 innercone
15 positioning pin
16 cutout
17 stop surface
18 cylindrical projection

What is claimed is:

1-12. (canceled)

13. A tool support for tools on machine tools, the tool support comprising:
a tool support receptacle;
a tool clamping insert arranged in the tool support receptacle and receiving a tool;
at least one clamping screw for fixation of the tool clamping insert in the tool support receptacle;
wherein the tool support receptacle has at least one continuous threaded bore having an axis that is positioned angularly relative to an axis of rotation of the tool;
wherein the at least one clamping screw when screwed into the at least one threaded bore engages in a tightened state a circumferential outer surface of the tool clamping insert.

14. The tool support according to claim 13, wherein the axis of the threaded bore is perpendicular to the axis of rotation of the tool.

15. The tool support according to claim 13, wherein the axis of the threaded bore, viewed in a direction of tightening of the at least one clamping screw, is positioned at an angle of smaller than 90 degrees relative to the axis of rotation of the tool.

16. The tool support according to claim 13, wherein the axis of the threaded bore, viewed in a direction of tightening of the at least one clamping screw, is positioned at an angle of greater than 90 degrees relative to the axis of rotation of the tool.

17. The tool support according to claim 13, wherein the at least one clamping screw has at its forward end a clamping cone and the tool clamping insert has an inner cone provided in the circumferential outer surface, wherein the inner cone is engaged by the clamping cone in the tightened state of the at least one clamping screw.

18. The tool support according to claim 17, wherein the clamping cone and the inner cone are embodied such that in the tightened state of the at least one clamping screw the tool clamping insert is axially forced into the tool support receptacle.

19. The tool support according to claim 17, wherein the circumferential outer surface of the tool clamping insert has a recess and said recess provided with the inner cone, wherein the recess is configured such that the at least one clamping screw, screwed at different angles into the tool support receptacle in accordance with an orientation of the at least one threaded bore, is secured with the forward end in said recess.

20. The tool support according to claim 13, wherein the tool clamping insert is substantially conical.

21. The tool support according to claim 20, wherein the tool clamping insert has a front end provided with a substantially cylindrical projection and the at least one clamping screw engages the cylindrical projection.

22. The tool support according claim 20, wherein the rearward end of the tool clamping insert has a cylindrical projection.

23. The tool support according to claim 22, wherein the cylindrical projection has a circumferential groove that receives an O-ring for providing a sealing action relative to the tool support receptacle.

24. The tool support according to claim 13, wherein a bottom of the tool clamping insert has an axially adjustable adjusting screw acting on the tool.

25. The tool support according to claim 13, wherein the tool support receptacle and the tool clamping insert each have facing end faces, wherein the end faces are provided with an axis-parallel positioning pin and a matching cutout arranged opposite one another in the end faces, respectively.
